(19) United States
(12) Patent Application Publication
(10) Pub. No.: US 2007/0222715 A1
(43) Pub. Date: Sep. 27, 2007

(54) Method and apparatus for driving plasma display panel (PDP)

(76) Inventor: Jung-Tae Park, Suwon-si (KR)

Correspondence Address: Robert E. Bushnell, Suite 300, 1522 K. Street, N.W., Washington, DC, 20005-1202, US

(21) Appl. No.: 11/727,323

(22) Filed: Mar. 26, 2007

(30) Foreign Application Priority Data
Mar. 27, 2006 (KR) 10-2006-0027450

(51) Int. Cl. G09G 3/28

(52) U.S. Cl. 345/67

(57) ABSTRACT

An apparatus and method to drive a Plasma Display Panel (PDP) having discharge cells arranged where X electrodes and Y electrodes cross each other includes: generating a driving control signal including X, Y, and A driving control signals according to an image signal of an image to be displayed; X, Y, and A drivers to respectively process the X, Y, and A driving control signals and to supply them to the X, Y, and A electrodes. In a sustain-discharge period, a sustain pulse voltage of a first level is alternately supplied to the X electrodes and the Y electrodes, and a first sustain pulse has a pulse width in a range between 3 μs and 10 μs.

### CLAIM OF PRIORITY

This application makes reference to, incorporates the same herein, and claims all benefits accruing under 35 U.S.C. §119 from an application for METHOD AND APPARATUS FOR DRIVING PLASMA DISPLAY PANEL earlier filed in the Korean Intellectual Property Office on 27 Mar. 2006 and there duly assigned Ser. No. 10-2006-0027450.

### BACKGROUND OF THE INVENTION

1. Field of the Invention

The present invention relates to a method and apparatus for driving a Plasma Display Panel (PDP), and more particularly, the present invention relates to a method and apparatus for driving a PDP in which a frame constituting a display period is divided into a plurality of subfields for a time division gray scale display, each subfield including a reset period, an address period, and a sustain-discharge period.

2. Description of the Related Art

Plasma Display Panels (PDPs) have come to public attention because they can be easily manufactured as large-sized flat panel displays. A PDP represents images using a discharge phenomenon. Generally, PDPs can be classified into DC PDPs and AC PDPs according to the driving voltage. Since DC PDPs have a long discharge delay time, the current focus is on the development of AC PDPs.

A representative AC PDP is a 3-electrode AC surface discharge PDP which includes three electrode groups and is driven by AC voltages. Since a 3-electrode surface discharge PDP, which is composed of a plurality of plates, is thinner and lighter than a conventional Cathode Ray Tube (CRT), the 3-electrode surface discharge PDP can provide a large-sized screen.

A conventional 3-electrode surface discharge type PDP and a driving apparatus and method thereof are discussed in U.S. Pat. No. 6,744,218 entitled “Method of Driving a Plasma Display Panel in which the Width of Display Sustain Pulse Varies”. The PDP and driving apparatus and method thereof discussed in U.S. Pat. No. 6,744,218 are included in the present application and a description thereof has been omitted.

A discharge gas is injected between two substrates of a PDP, discharge voltages are supplied to the electrodes, vacuum ultraviolet radiation is generated by a discharge, and the vacuum ultraviolet radiation excites phosphors formed in a predetermined pattern, thereby displaying images.

The PDP discussed above includes a plurality of display cells in which sustain electrodes and address electrodes cross each other, each display cell consisting of three (red, green, and blue) discharge cells and a gray scale of an image being represented by adjusting discharge states of the discharge cells. Sustain electrodes include X electrodes and Y electrodes.

In order to represent the gray scale of the PDP, each of the frames supplied to the PDP is divided into 8 subfields having different light-emitting frequencies, thereby representing 256 gray scales. In order to display an image using 256 gray scales, a frame period (16.67 ms) corresponding to 1/60 second is divided into 8 subfields.

Each subfield is divided into a reset period for initializing all of the discharge cells, an address period for selecting display cells, and a sustain-discharge period for displaying a discharge in the discharge cells selected in the address period.

In the reset period and the address period, a sustain discharge can be performed in the discharge cells selected in the sustain-discharge period. However, it is necessary to precisely perform the discharge in the discharge cells selected in the sustain-discharge period by a first sustain pulse in order to stably perform the sustain discharge.

### SUMMARY OF THE INVENTION

The present invention provides a method and apparatus for driving a Plasma Display Panel (PDP) that restricts the range of a time width of a first sustain pulse in a sustain-discharge period in order to secure a stable discharge.

According to one aspect of the present invention, an apparatus to drive a Plasma Display Panel (PDP) having discharge cells arranged where X electrodes and Y electrodes cross address electrodes, in which each frame which is a display period includes a plurality of subfields to display a time division gray scale, each subfield having a reset period to initialize all of the discharge cells, an address period to select the discharge cells that are to have a discharge from all of the discharge cells, and a sustain-discharge period to perform a sustain discharge in the selected discharge cells is provided, the apparatus including: a logical controller to generate a driving control signal including an X driving control signal, a Y driving control signal, and an A driving control signal according to an image signal of an image to be displayed; an X driver to process the X driving control signal and to supply the X driving control signal to the X electrodes; an Y driver to process the Y driving control signal and to supply the Y driving control signal to the Y electrodes; and an A driver to process the A driving control signal and to supply the A driving control signal to the address electrodes; in the sustain-discharge period, a sustain pulse voltage of a first level is alternately supplied to the X electrodes and the Y electrodes, and a first sustain pulse has a pulse width in a range between 3 μs and 10 μs.

The apparatus preferably further includes a discharge gas contained within the discharge cells, the discharge gas including at least xenon Xe and helium He. An amount of He in the discharge gas is preferably greater than an amount of Xe. The amount of Xe in the discharge gas is preferably in a range between 2% and 20%. The amount of Xe in the discharge gas is preferably in a range between 4% and 14%. The amount of Xe in the discharge gas is preferably in a range between 6% and 12%. The amount of He in the discharge gas is preferably in a range between 15% and 50%.

A pressure of the discharge gas is preferably in a range between 400 Torr and 550 Torr.

An amount of Xe in the discharge gas is preferably in a range between 2% and 20%, the amount of He in the discharge gas is in a range between 15% and 50%, the amount of He in the discharge gas is greater than the amount of Xe, and a pressure of the discharge gas mixture is in a range between 400 Torr and 550 Torr.

According to another aspect of the present invention, a method of driving a Plasma Display Panel (PDP) having discharge cells arranged where X electrodes and Y electrodes cross each other, in which each frame which is a display period includes a plurality of subfields to display a time division gray scale, each subfield having a reset period to initialize all of the discharge cells, an address period to select the discharge cells that are to have a discharge from all of the discharge cells, and a sustain-discharge period to perform a sustain discharge in the selected discharge cells is provided, the method including: generating a driving control signal including an X driving control signal, a Y driving control signal, and an A driving control signal according to an image signal of an image to be displayed; processing the X driving control signal and supplying the X driving control signal to the X electrodes; processing the Y driving control signal and supplying the Y driving control signal to the Y electrodes; and processing the A driving control signal and supplying the A driving control signal to the address electrodes; in the sustain-discharge period, a sustain pulse voltage of a first level is alternately supplied to the X electrodes and the Y electrodes, and a first sustain pulse has a pulse width in a range between 3 μs and 10 μs.

The method preferably further includes injecting a discharge gas within the discharge cells, the discharge gas including at least xenon Xe and helium He. An amount of He in the discharge gas is preferably greater than an amount of Xe. The amount of Xe in the discharge gas is preferably in a range between 2% and 20%. The amount of Xe in the discharge gas is preferably in a range between 4% and 14%. The amount of Xe in the discharge gas is preferably in a range between 6% and 12%. The amount of He in the discharge gas is preferably in a range between 15% and 50%.

A pressure of the discharge gas is preferably in a range between 400 Torr and 550 Torr.

An amount of Xe in the discharge gas is preferably in a range between 2% and 20%, the amount of He in the discharge gas is in a range between 15% and 50%, the amount of He in the discharge gas is greater than the amount of Xe, and a pressure of the discharge gas mixture is in a range between 400 Torr and 550 Torr.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a perspective view of a 3-electrode surface discharge PDP to which a PDP driving apparatus according to an embodiment of the present invention is applied;

FIG. 2 is a block diagram of the PDP driving apparatus of FIG. 2 according to an embodiment of the present invention;

FIG. 3 is a timing diagram of a PDP driving method in which a unit frame is divided into a plurality of subfields, according to an embodiment of the present invention;

FIG. 4 is a timing diagram of driving signals output from each of the drivers of the PDP of FIG. 2 according to an embodiment of the present invention; and

FIG. 5 is a graph of the improvement of luminous efficiency according to variations in the amount of helium with respect to variations in the amount of xenon in a discharge gas mixture including neon, xenon, and helium according to an embodiment of the present invention;

FIG. 6 is a graph of the improvement of luminous efficiency according to variations in the amount of xenon with respect to variations in the amount of helium in a discharge gas mixture including neon, xenon, and helium according to an embodiment of the present invention;

FIG. 7 is a graph of brightness maintenance and luminous efficiency with respect to the pressure of discharge gas in a discharge gas mixture including neon Ne, xenon Xe, and helium He according to an embodiment of the present invention; and

FIG. 8 is a graph of the number of on-cells with respect to the variations of the pulse width of a first sustain pulse in a sustain-discharge period according to an embodiment of the present invention.

### DETAILED DESCRIPTION OF THE INVENTION

The present invention is described more fully below with reference to the accompanying drawings, in which exemplary embodiments of the present invention are shown.

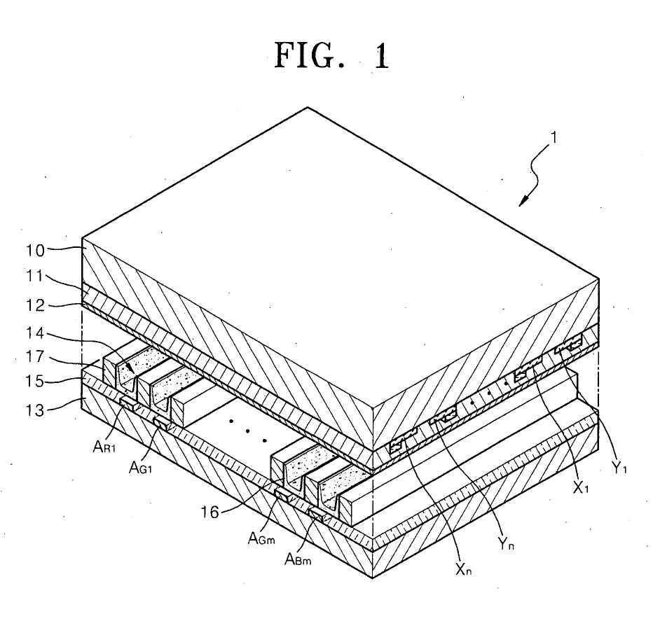

FIG. 1 is a perspective view of a 3-electrode surface discharge PDP 1 to which a PDP driving apparatus according to an embodiment of the present invention is applied.

Referring to FIG. 1, address electrodes A_{R1}, . . . , A_{Bm}, upper and lower dielectric layers 11 and 15, Y electrodes Y₁, . . . , Yₙ, X electrodes X₁, . . . , Xₙ, phosphor layers 16, barrier ribs 17, and a MgO layer 12 which is a protection layer, are formed between front and rear glass substrates 10 and 13 of the surface discharge PDP 1.

The address electrodes A_{R1}, . . . , A_{Bm} are formed in a predetermined pattern on an upper surface of the rear glass substrate 13. The lower dielectric layer 15 buries the address electrodes A_{R1}, . . . , A_{Bm}. The barrier ribs 17 are formed parallel to the address electrodes A_{R1}, . . . , A_{Bm} on a surface of the lower dielectric layer 15. The barrier ribs 17 partition discharge areas and prevent cross-talk between the discharge areas. The phosphor layers 16 are formed on sidewalls of the barrier ribs 17 and on the lower dielectric layer 15 formed on the rear glass substrate 13.

The X electrodes X₁, . . . , Xₙ and the Y electrodes Y₁, . . . , Yₙ are formed in a predetermined pattern on a lower surface of the front glass substrate 10 such that they cross the address electrodes A_{R1}, . . . , A_{Bm}. Discharge cells 14 are defined where the X electrodes X₁, . . . , Xₙ and the Y electrodes Y₁, . . . , Yₙ intersect the address electrodes A_{R1}, . . . , A_{Bm}. Each of the X electrodes X₁, . . . , Xₙ and each of the Y electrodes Y₁, . . . , Yₙ are formed by coupling a transparent conductive electrode formed of a material, such as Indium Tin Oxide (ITO) with a metal electrode for increasing conductivity. The X electrodes X₁, . . . , Xₙ are common electrodes of the respective discharge cells 14, and the Y electrodes Y₁, . . . , Yₙ are scan electrodes of the respective discharge cells 14.

The Y electrodes Y₁, . . . , Yₙ are scan electrodes to which a scan pulse is sequentially supplied to select the discharge cells 14 that are to be displayed. The X electrodes X₁, . . . , Xₙ are sustain electrodes that performs a sustain discharge between the X electrodes X₁, . . . , Xₙ and the Y electrodes Y₁, . . . , Yₙ.

A discharge gas is injected into the discharge cells. A voltage is supplied to the electrode lines to generate a plasma using the discharge gas. Ultraviolet radiation excites phosphors to radiate visible light through the glass substrate 10 of the front side of the PDP, thereby displaying images.

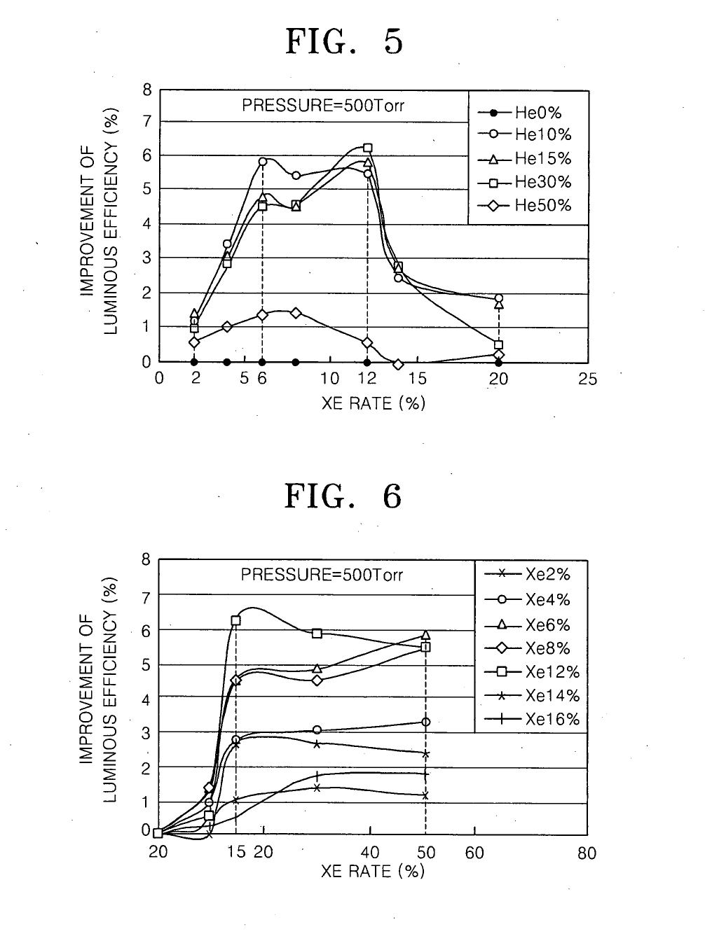

To this end, the discharge gas is a mixture of helium He, neon Ne, and xenon Xe. As shown in FIGS. 5 through 7, the ratio and pressure of the mixture can increase ultraviolet production efficiency.

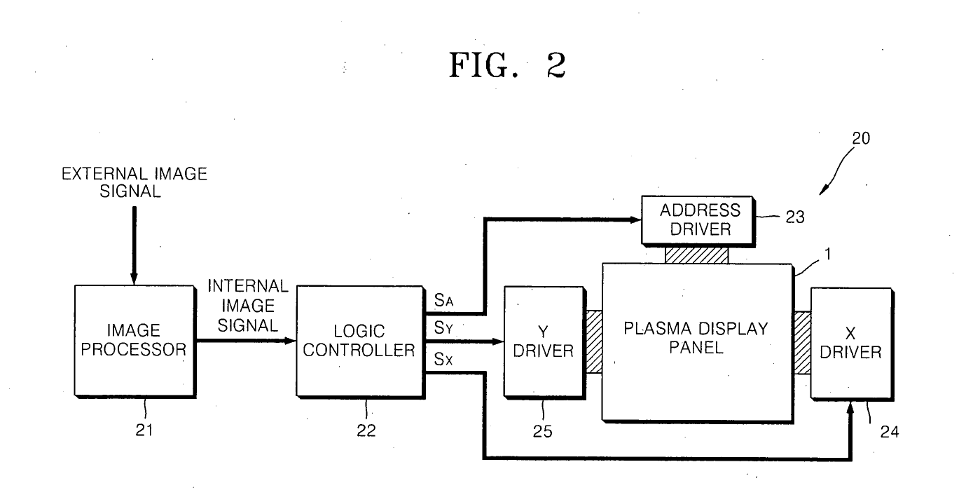

FIG. 2 is a block diagram of the PDP driving apparatus 20 of FIG. 1 according to an embodiment of the present invention.

Referring to FIG. 2, the PDP driving apparatus 20 includes an image processor 21, a logic controller 22, an address driver 23, an X driver 24, and a Y driver 25. The image processor 21 converts external analog image signals into digital signals and generates internal image signals, for example, red (R), green (G), and blue (B) image data signals, a clock signal, and vertical and horizontal synchronization signals. The logic controller 22 generates driving control signals S_{A}, S_{Y}, and S_{X} according to the internal image signals received from the image processor 26. The address driver 23, the X driver 24, and the Y driver 25 receive the driving control signals S_{A}, S_{Y}, and S_{X}, generate the corresponding driving control signals S_{A}, S_{Y}, and S_{X}, and supply the generated driving control signals S_{A}, S_{Y}, and S_{X} to the corresponding electrodes.

That is, the address driver 23 supplies a display data signal according to the address driving control signal S_{A} received from the logic controller 22 to the address electrodes. The X driver 24 processes the X driving control signal S_{X} received from the logic controller 22, and supplies a voltage corresponding to the X driving control signal S_{X} to the X electrodes. The Y driver 25 processes the Y driving control signal S_{Y} received from the logic controller 22, and supplies a voltage corresponding to the Y driving control signal S_{Y} to the Y electrodes.

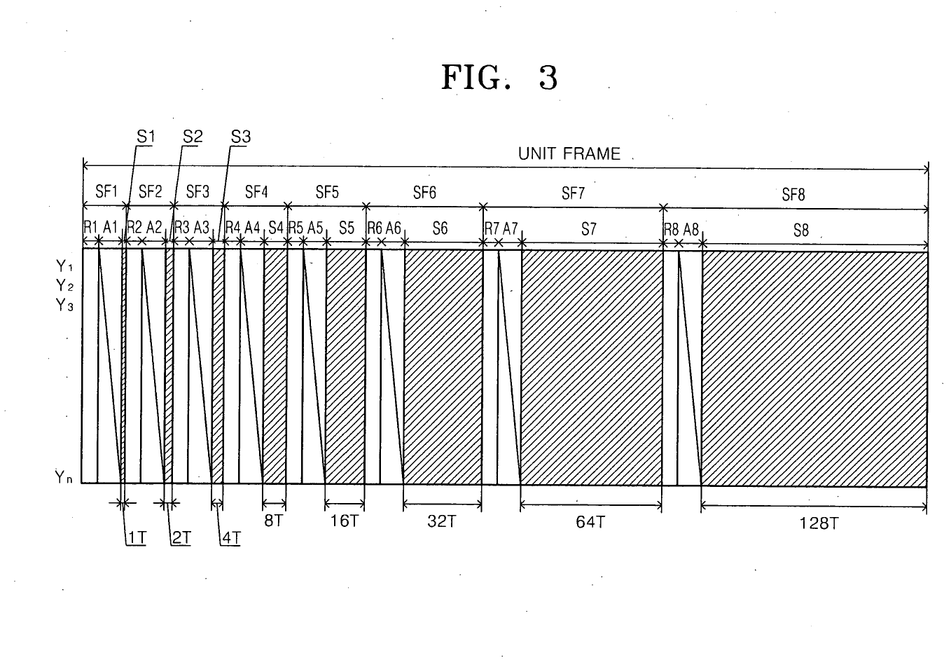

FIG. 3 is a timing diagram of a PDP driving method in which a unit frame is divided into a plurality of subfields, according to an embodiment of the present invention.

Referring to FIG. 3, the unit frame FR is divided into 8 subfields SF1, . . . , SF8 for a time division gray scale display. Also, the respective subfields SF1, . . . , SF8 are respectively divided into reset periods R1, . . . , R8, address periods A1, . . . , A8, and sustain discharge periods S1, . . . , S8.

The brightness of the PDP is proportional to the length of the sustain discharge periods S1, . . . , S8 in a unit frame. The length of the sustain discharge periods S1, . . . , S8 in a unit frame is 255 T (T is a unit time). A time corresponding to 2ⁿ is set to the sustain discharge period Sn of an n-th subfield SFn. Accordingly, by appropriately selecting subfields to be displayed among 8 subfields, 256 gray scales including a zero gray scale which is not displayed in any subfield can be displayed.

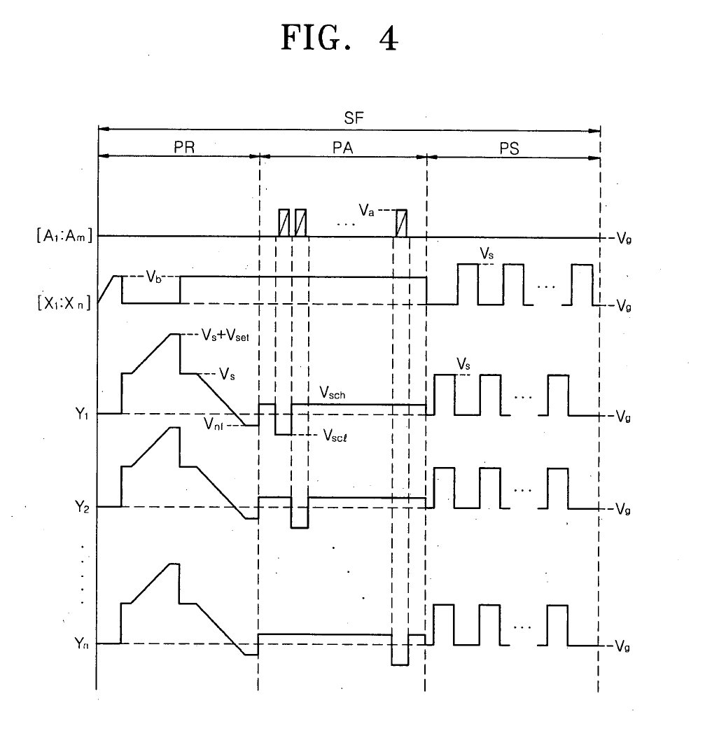

FIG. 4 is a timing diagram of driving signals output from each of the drivers of the PDP 1 of FIG. 2 according to an embodiment of the present invention.

Referring to FIG. 4, a unit frame for driving the PDP 1 of FIG. 2 is divided into a plurality of subfields, wherein each subfield has a gray scale weight for driving time division gray scale display, and each subfield SF includes a reset period PR, an address period PA, and a sustain-discharge period PS.

In the reset period PR, a reset pulse including a rising pulse and a falling pulse is supplied to Y electrodes Y₁ through Yₙ and a second voltage (a bias voltage) is supplied to X electrodes X₁ through Xₙ to perform a reset discharge when the falling pulse is supplied. The reset discharge initializes all discharge cells. The rising pulse rises from a sustain-discharge voltage Vs through a rising voltage Vₛₑₜ to a rising maximum voltage Vₛₑₜ+Vs. The falling pulse falls from the sustain discharge voltage Vs to a falling maximum voltage V_{nf}.

In the address period PA, a scan pulse is sequentially supplied to the Y electrodes Y₁ through Yₙ, and a display data signal is supplied to A electrodes A₁ through Aₘ in accordance with the scan pulse to perform an address discharge, so that the discharge cells for performing a sustain discharge in the sustain-discharge period PS can be selected. The scan pulse sequentially has a scan high voltage Vsch and a scan low voltage Vscl. The display data signal has a positive address voltage Va in accordance with the application of the scan low voltage Vscl of the scan pulse.

In the sustain-discharge period PS, a sustain pulse is alternately supplied to the X electrodes X₁ through Xₙ and Y electrodes Y₁ through Yₙ to perform a sustain discharge. The sustain discharge presents brightness according to gray weights allocated to each subfield. The sustain pulse has alternatively has a sustain discharge voltage Vs and a ground voltage Vg.

The time width Tₛ₁ of a first sustain pulse voltage maybe between 3 μs and 10 μs, in order to obtain a stable discharge.

In the reset period PR and the address period PA, the sustain discharge can be performed in the discharge cells selected in the sustain-discharge period PS. A discharge needs to be absolutely performed by the first sustain pulse in the discharge cells selected in the sustain-discharge period in order to perform a stable sustain period.

Therefore, the present invention can stably obtain the first sustain discharge by restricting the range of the time width Ts1 of a first sustain pulse voltage. Also, a priming effect can occur from the first sustain discharge in order to more stably perform the sustain discharge from the next sustain pulses.

According to the current embodiment of the present invention, the driving signals of FIG. 4 are not necessarily limited thereto but other driving signals can be output from each of the drivers of FIG. 2.

FIG. 5 is a graph of the improvement of luminous efficiency according to variations in the amount of helium with respect to variations in the amount of xenon in a discharge gas mixture including neon Ne, xenon Xe, and helium He according to an embodiment of the present invention. FIG. 6 is a graph of the improvement of luminous efficiency according to variations in the amount of xenon with respect to variations in the amount of helium in a discharge gas mixture including neon, xenon, and helium according to an embodiment of the present invention.

Referring to FIGS. 5 and 6, the present invention can use the mixture of Ne, X, and He as discharge gas in order to perform a plasma discharge in the discharge cells. However, although small amounts of an impurity gas can be used as the discharge gas, the present invention maintains its discharge characteristics.

The luminous efficiency can be improved according to a mixture ratio of Ne, Xe, and He. Therefore, according to the current embodiment of the present invention, the discharge gas mixture has the mixture ratio sufficient to improve the luminous efficiency. The mixture ratio is determined according to the proportion of each gas of the overall discharge gas mixture, or according to the proportion of particles (molecules or atoms) or pressure ratio in each discharge gas with respect to the pressure of the discharge gas. The luminous efficiency can be measured according to a ratio of luminous brightness and power supplied to a PDP. The luminous efficiency is measured at a pressure of 500 Torr.

Referring to FIG. 5, the luminous efficiency increases as the amount of Xe increases from 2% to 20%. If the amount of Xe is smaller than 2%, the luminous efficiency is too low to use the PDP. If the amount of Xe is greater than 20%, the PDP cannot be operated without a rapid increase in a sustain discharge voltage. Therefore, the amount of Xe should be between 2% and 20%.

If the amount of Xe is between 2% and 20% and the amount of He is between 15% and 50%, the luminous efficiency increases. Therefore, if the amount of Xe is between 2% and 20%, the amount of He should be between 15% and 50%.

The amount of Xe should be between 4% and 14%. In more detail, the luminous efficiency increases when the amount of Xe is between 4% and 14%.

The amount of Xe should more preferably be between 6% and 12%. In more detail, the luminous efficiency increases when the amount of Xe is between 6% and 12%.

Referring to FIG. 6, the amount of He should be between 15% and 50%. In more detail, the luminous efficiency rapidly increases when the amount of He is 15%. However, if the amount of He is greater than 50%, since the lifetime of the PDP is rapidly reduced, the PDP is not practically used.

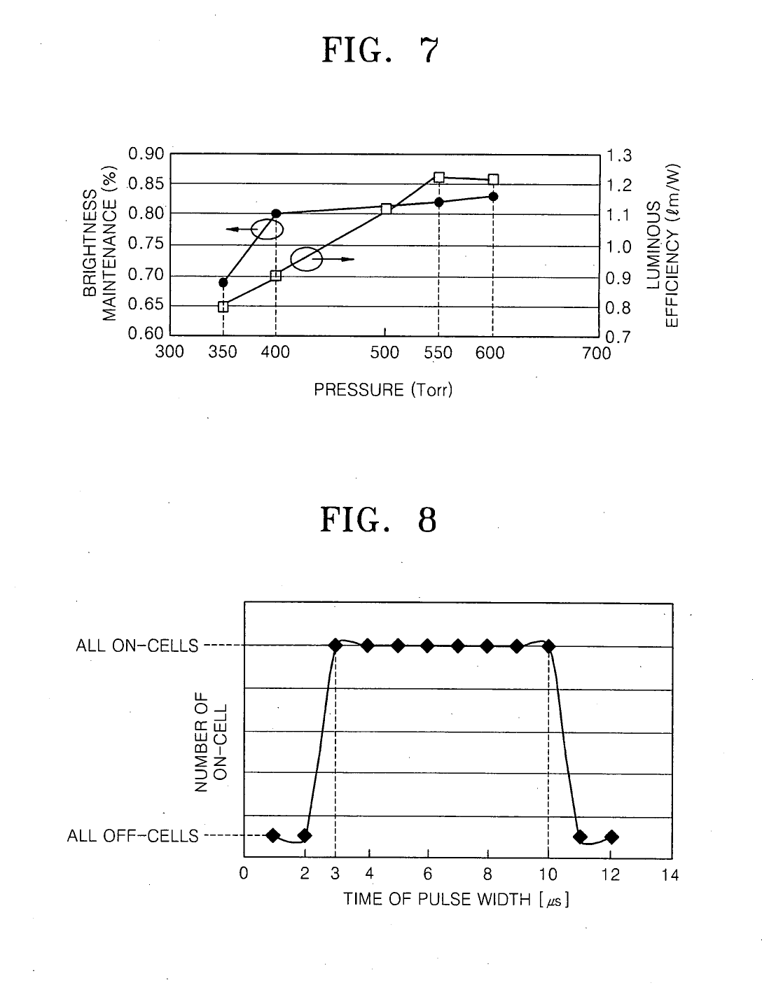

FIG. 7 is a graph of brightness maintenance and luminous efficiency with respect to the pressure of the discharge gas in a discharge gas mixture including neon Ne, xenon Xe, and helium He according to an embodiment of the present invention.

Referring to FIG. 7, the lifetime and luminous efficiency of a PDP can be improved according to the pressure of the discharge gas. The variations of the lifetime and luminous efficiency of the PDP are measured between 350 Torr and 600 Torr of the pressure of the discharge gas including Ne, Xe, and He. The variations of the lifetime and luminous efficiency of the PDP are measured using a discharge of the discharge gas mixture of Ne 62%, Xe 8%, and He 30%.

The lifetime of the PDP is determined by the brightness maintenance after the PDP has been operated for 672 hours. The luminous efficiency is measured according to a ratio of power supplied to the PDP and luminous brightness. Circles indicate the brightness maintenance and squares indicate luminous efficiency.

According to the current embodiment of the present invention, the pressure of the discharge gas mixture should be between 400 Torr and 550 Torr. If the pressure is less than 400 Torr, since the brightness maintenance is rapidly reduced, the PDP cannot be used. If the pressure is greater than 550 Torr, since the luminous efficiency cannot increase according to the variations of the voltage supply, the PDP can be damaged due to a small difference between the pressure and atmospheric pressure.

Therefore, the pressure of the discharge gas mixture should preferably be between 400 Torr and 550 Torr.

FIG. 8 is a graph of the number of on-cells with respect to the variations of the pulse width of a first sustain pulse in a sustain-discharge period according to an embodiment of the present invention.

Referring to FIG. 8, when a PDP is operated using the method of FIGS. 3 and 4, the number of cells which are turned on by a successful sustain discharge varies according to the pulse width of the first sustain pulse supplied to X electrodes and Y electrodes in the sustain-discharge period.

In more detail, if the amount of Xe is between 2% and 20%, the amount of He is between 15% and 50%, the amount of He is greater than the amount of Xe, and the pressure of the discharge gas mixture is between 400 Torr and 550 Torr, the sustain discharge is successfully performed in all of the discharge cells between 3 μs and 10 μs of the pulse width of the first sustain pulse.

Therefore, the pulse width of the first sustain pulse should be between 3 μs and 10 μs. If the pulse width of the first sustain pulse is smaller than 3 μs, the PDP cannot stably perform a discharge, which causes a low discharge. If the pulse width of the first sustain pulse is greater than 10 μs, since the PDP has a lot of energy, a self erasing effect is produced due to an over-discharge, which causes the lower discharge.

In more detail, if the amount of Xe is between 2% and 20%, the amount of He is between 15% and 50%, the amount of He is greater than the amount of Xe, and the pressure of the discharge gas mixture is between 400 Torr and 550 Torr, the sustain discharge is performed between 3 μs and 10 μs of the pulse width of the first sustain pulse, thereby obtaining a stable discharge and high efficiency and lifetime.

According to the method and apparatus for driving a PDP of an embodiment of the present invention, the range of the time width of a first sustain pulse in a sustain-discharge period is restricted, thereby obtaining a stable discharge.

While the present invention has been particularly shown and described with reference to exemplary embodiments thereof, it will be understood by those of ordinary skill in the art that various modifications in form and detail may be made therein without departing from the spirit and scope of the present invention as defined by the following claims.

What is claimed is:

1. An apparatus to drive a Plasma Display Panel (PDP) having discharge cells arranged where X electrodes and Y electrodes cross address electrodes, in which each frame which is a display period includes a plurality of subfields to display a time division gray scale, each subfield having a reset period to initialize all of the discharge cells, an address period to select the discharge cells that are to have a discharge from all of the discharge cells, and a sustain-discharge period to perform a sustain discharge in the selected discharge cells, the apparatus comprising:
a logical controller to generate a driving control signal including an X driving control signal, a Y driving control signal, and an A driving control signal according to an image signal of an image to be displayed;
an X driver to process the X driving control signal and to supply the X driving control signal to the X electrodes;
an Y driver to process the Y driving control signal and to supply the Y driving control signal to the Y electrodes; and
an A driver to process the A driving control signal and to supply the A driving control signal to the address electrodes;
wherein, in the sustain-discharge period, a sustain pulse voltage of a first level is alternately supplied to the X electrodes and the Y electrodes, and wherein a first sustain pulse has a pulse width in a range between 3 μs and 10 μs.

2. The apparatus of claim 1, further comprising a discharge gas contained within the discharge cells, the discharge gas including at least xenon Xe and helium He.

3. The apparatus of claim 2, wherein an amount of He in the discharge gas is greater than an amount of Xe.

4. The apparatus of claim 3, wherein the amount of Xe in the discharge gas is in a range between 2% and 20%.

5. The apparatus of claim 4, wherein the amount of Xe in the discharge gas is in a range between 4% and 14%.

6. The apparatus of claim 5, wherein the amount of Xe in the discharge gas is in a range between 6% and 12%.

7. The apparatus of claim 4, wherein the amount of He in the discharge gas is in a range between 15% and 50%.

8. The apparatus of claim 2, wherein a pressure of the discharge gas is in a range between 400 Torr and 550 Torr.

9. The apparatus of claim 2, wherein an amount of Xe in the discharge gas is in a range between 2% and 20%, the amount of He in the discharge gas is in a range between 15% and 50%, the amount of He in the discharge gas is greater than the amount of Xe, and a pressure of the discharge gas mixture is in a range between 400 Torr and 550 Torr.

10. A method of driving a Plasma Display Panel (PDP) having discharge cells arranged where X electrodes and Y electrodes cross each other, in which each frame which is a display period includes a plurality of subfields to display a time division gray scale, each subfield having a reset period to initialize all of the discharge cells, an address period to select the discharge cells that are to have a discharge from all of the discharge cells, and a sustain-discharge period to perform a sustain discharge in the selected discharge cells, the method comprising:
generating a driving control signal including an X driving control signal, a Y driving control signal, and an A driving control signal according to an image signal of an image to be displayed;
processing the X driving control signal and supplying the X driving control signal to the X electrodes;
processing the Y driving control signal and supplying the Y driving control signal to the Y electrodes; and
processing the A driving control signal and supplying the A driving control signal to the address electrodes;
wherein, in the sustain-discharge period, a sustain pulse voltage of a first level is alternately supplied to the X electrodes and the Y electrodes, and wherein a first sustain pulse has a pulse width in a range between 3 μs and 10 μs.

11. The method of claim 10, further comprising injecting a discharge gas within the discharge cells, the discharge gas including at least xenon Xe and helium He.

12. The method of claim 11, wherein an amount of He in the discharge gas is greater than an amount of Xe.

13. The method of claim 12, wherein the amount of Xe in the discharge gas is in a range between 2% and 20%.

14. The method of claim 13, wherein the amount of Xe in the discharge gas is in a range between 4% and 14%.

15. The method of claim 14, wherein the amount of Xe in the discharge gas is in a range between 6% and 12%.

16. The method of claim 15, wherein the amount of He in the discharge gas is in a range between 15% and 50%.

17. The method of claim 11, wherein a pressure of the discharge gas is in a range between 400 Torr and 550 Torr.

18. The method of claim 11, wherein an amount of Xe in the discharge gas is in a range between 2% and 20%, the amount of He in the discharge gas is in a range between 15% and 50%, the amount of He in the discharge gas is greater than the amount of Xe, and a pressure of the discharge gas mixture is in a range between 400 Torr and 550 Torr.
